(19) United States
(12) Patent Application Publication
(10) Pub. No.: US 2020/0122355 A1
(43) Pub. Date: Apr. 23, 2020

(54) METHOD, COMPOSITION AND DEVICE FOR PRODUCING SILICON CARBIDE-CONTAINING STRUCTURES

(71) Applicant: PSC Technologies GmbH, Berlin (DE)

(72) Inventors: Siegmund GREULICH-WEBER, Bad Lippspringe (DE); Rüdiger SCHLEICHER-TAPPESER, Berlin (DE)

(73) Assignee: PSC Technologies GmbH, Berlin (DE)

(21) Appl. No.: 16/612,512

(22) PCT Filed: May 9, 2018
(86) PCT No.: PCT/EP2018/062004

§ 371 Date: Nov. 11, 2019

(30) Foreign Application Priority Data
May 12, 2017 (DE) 10 2017 110 361.9

(51) Int. Cl. B28B 1/00; B33Y 10/00; B33Y 30/00; B33Y 70/00; B33Y 40/00

(52) U.S. Cl. CPC B28B 1/001; B33Y 10/00; B33Y 40/00; B33Y 70/00; B33Y 30/00

(57) ABSTRACT

The invention relates to a method for the production of a silicon carbide-containing structure, in particular by means of additive manufacturing, to a liquid composition for producing the silicon carbide-containing structure and to a device for carrying out the method.

### CROSS-REFERENCES TO RELATED APPLICATIONS

This application is a National Stage filing of International Application PCT/EP 2018/062004, filed May 9, 2018, entitled METHOD, COMPOSITION AND DEVICE FOR PRODUCING SILICON CARBIDE-CONTAINING STRUCTURES, claiming priority to DE 10 2017 110 361.9, filed May 12, 2017. The subject application claims priority to PCT/EP 2018/062004 and to DE 10 2017 110 361.9 and incorporates all by reference herein, in their entirety.

### BACKGROUND OF THE INVENTION

The present invention relates to the technical field of generative manufacturing methods, in particular additive manufacturing.

In particular, the present invention relates to a method for the production of a silicon carbide-containing structure, in particular a silicon carbide-containing three-dimensional object.

Furthermore, the present invention relates to a composition, in particular a SiC precursor sol, for the production of a silicon carbide-containing structure by means of additive manufacturing and the use of a liquid composition for the production of a silicon carbide-containing structure.

Finally, the present invention relates to an apparatus for the production of three-dimensional silicon carbide-containing objects from liquid solutions or dispersions, in particular precursor sols.

Generative manufacturing methods, also known as additive manufacturing (AM), are methods for the rapid production of models, samples, tools and products from formless materials such as liquids, gels, pastes or powders.

Orginally, generative manufacturing methods, in particular additive manufacturing, were generally referred to as 3D printing or rapid prototyping; in the meantime, however, the terms only refer to special forms of generative manufacturing methods. Generative manufacturing methods are used both for the production of objects from inorganic materials, especially ceramics, and from organic materials, especially thermoplastic or thermosetting polymers.

Preferably high-energy processes such as selective laser melting, electron beam melting or deposition welding are used for the production of objects from inorganic materials, since the reactants or precursors used react or melt only with a higher energy input.

In principle, additive manufacturing enables the rapid production of highly complex components, but the production of components from inorganic materials in particular sets a number of requirements for both the reactants and the product materials: For example, the reactants may only react in a predetermined manner under the effect of energy; in particular, disturbing side reactions are to be ruled out. Furthermore, no segregation of the products or a phase separation or decomposition of the products may occur under the effect of energy.

An extremely interesting and versatile material for ceramic materials and semiconductor applications is silicon carbide, also known as carborundum. Silicon carbide, with the chemical formula SiC, has an extremely high hardness and a high melting point and is frequently used as an abrasive or insulator in high-temperature reactors. Silicon carbide is also used with a number of elements and compounds, alloys or alloy-like compounds, which offer a variety of advantageous material properties, such as high hardness, high resistance, low weight and low oxidation sensitivity even at high temperatures.

Silicon carbide-containing materials are usually sintered at high temperatures, resulting in relatively porous bodies suitable only for a limited number of applications.

The properties of the porous silicon carbide material produced by sintering do not correspond to those of compact crystalline silicon carbide, so that the advantageous properties of silicon carbide cannot be fully exploited.

In addition, silicon carbide does not melt but sublimes at high temperatures—depending on the crystal type—in the range between 2,300 and 2,700° C., i.e. it changes from a solid to a gaseous state of aggregation. This makes silicon carbide particularly unsuitable for additive manufacturing processes such as laser melting.

Due to the versatility of silicon carbide and its compounds, attempts were nevertheless made to process silicon carbide using generative manufacturing methods.

For example, the German patent application DE10 2015 105 085 A1 describes a process for the production of objects from silicon carbide crystals, wherein the silicon carbide is obtained in particular by laser radiation from suitable carbon and silicon containing precursor compounds. When the laser beam is applied, the precursor compounds decompose selectively and silicon carbide is formed without the silicon carbide sublimating.

However, a disadvantage of such powder bed processes is that a large quantity of the starting powder always has to be provided in order to produce the three-dimensional object layer by layer in the powder bed, i.e. a large excess of material is always used, which requires storage and thus increases the process costs.

In addition, especially in reactive processes, i.e. processes in which the target compound first reacts from precursors to the desired target compounds through the effect of energy or chemical reaction, there is a risk that parts of the powder bed become contaminated and then have to be laboriously cleaned or disposed of. This means that the material used cannot be completely converted to the target compound, which also significantly increases the process costs due to the greater use of material.

In the field of additive manufacturing from organic polymers there are methods in which photopolymers are applied to a substrate locally limited, in particular regioselectively, layer by layer and reacted by means of UV radiation, through which a three-dimensional object is built up layer by layer. The regioselective application of the photopolymer is usually carried out via printing processes, in particular ink jet printing, whereby only the amount of material required to build up the next layer of the three-dimensional object is applied in a resource-saving manner. Such ink-jet printing processes could also lead to significant material savings in the area of inorganic materials, especially in the production of silicon carbide-containing materials, and thus would enable the processes to be carried out economically.

Furthermore, the use of printing techniques in principle also permits the generation of very thin layer-like structures, which are interesting for applications in semiconductor technology, for example.

However, there is no equivalent of this concept in the field of inorganic materials, especially silicon carbide-containing materials.

A direct transfer of ink-jet printing processes for the production of inorganic materials by means of additive manufacturing is usually not possible, since inorganic materials, in opposition to photopolymers, do not crosslink quickly and without heat supply by means of photochemically excitable functional groups, but are melted or split into reactive components by the input of higher amounts of energy.

For this reason, objects made of inorganic materials are usually produced by sintering within the context of additive manufacturing.

Furthermore, there is also a lack of suitable starting materials, especially precursors, which can be used in printing processes, especially inkjet printing processes, since powders are usually used in the additive production of inorganic materials.

### BRIEF SUMMARY OF THE INVENTION

It is therefore an objective of the present invention to avoid or at least mitigate the disadvantages and problems associated with the state of the art described above.

In particular, one objective of the present invention is to provide methods for the production of silicon carbide-containing materials by means of additive manufacturing, which are not limited to powder bed processes.

A further objective of the present invention is to provide a generative manufacturing method for the production of silicon carbide-containing structures, which enables the locally limited or regioselective application of suitable starting materials, i.e. precursor materials, for the production of silicon carbide-containing materials and can thus be carried out in a material-saving manner.

Finally, a further objective of the present invention is to provide a precursor material which can be easily processed universally to desired silicon carbide-containing compounds, especially high-performance ceramics or materials for semiconductor applications, and which can be used in printing processes for additive production.

Subject-matter of the present invention according to a first aspect of the present invention is a method for the production of a silicon carbide-containing structure; further advantageous embodiments of this aspect of the invention are provided.

Further subject-matter of the present invention according to a second aspect of the present invention is a silicon carbide-containing structure.

Again, further subject-matter of the present invention according to a third aspect of the present invention is a composition; further advantageous embodiments of this aspect of the present invention are disclosed.

Another subject-matter of the present invention according to a fourth aspect of the present invention is the use of a composition.

Finally, further subject-matter of the present invention is an apparatus further disclosed.

It goes without saying that the particular features mentioned in the following, in particular special embodiments or the like, which are only described in relation to one aspect of the invention, also apply in relation to the other aspects of the invention, without this requiring any express mention.

Furthermore, for all relative or percentage, in particular weight-related, quantities or amounts stated below, it is to be noted that, within the framework of this invention, these are to be selected by the person skilled in the art in such a way that the sum of the ingredients, additives or auxiliary substances or the like always results in 100 percent or 100 percent by weight. This, however, goes without saying for the person skilled in the art.

In addition, the skilled person may deviate from the values, ranges or quantities listed below, depending on the application and individual case, without leaving the scope of this invention.

In addition, all of the parameters specified below or the like can be determined by standardized or explicitly specified determination methods or by common determination methods known per se by the person skilled in the art.

### BRIEF DESCRIPTION OF THE DRAWINGS

FIG. 1 provides a cross section through an inventive apparatus along an xz plane,

FIG. 2 provides an enlarged section from FIG. 1, in which the carbon- and silicon-containing solution or dispersion is applied to a substrate,

FIG. 3 also provides an enlarged section of FIG. 1, in which a layer of a carbon- and silicon-containing solution or dispersion applied to a substrate is converted to silicon carbide by laser radiation,

FIG. 4 provides an arrangement of storage devices for receiving and dispensing precursor sols or components of precursor sols and spreading means for applying a solution or dispersion,

FIG. 5 provides an alternative arrangement of storage devices for receiving and dispensing precursor sols or their components and spreading means for applying the solution or dispersion and

FIG. 6 provides a preferred embodiment of the present invention, in which both spreading means for applying a solution or dispersion to a substrate and means for directing radiation are arranged on a discharge device.

### DETAILED DESCRIPTION OF THE INVENTION

With this provision made, the subject-matter of the present invention is explained in more detail in the following.

Subject-matter of the present invention—according to a first aspect of the present invention—is thus a method for the production of a silicon carbide-containing structure, in particular by additive manufacturing, wherein
(a) in a first method step, a carbon- and silicon-containing solution or dispersion, in particular a SiC precursor sol, preferably a layer of a carbon- and silicon-containing liquid, in particular of a SiC precursor sol, is applied to a substrate, and
(b) in a second method step following the first method step (a), the carbon- and silicon-containing solution or dispersion, preferably the layer of the carbon- and silicon-containing solution or dispersion, is converted, in particular at least in some areas, by the effect of energy into a silicon carbide-containing compound, so that a part, in particular a layer, of the silicon carbide-containing structure is produced,
   wherein method steps (a) and (b) are repeated until the silicon carbide-containing structure is obtained.

For, as has been surprisingly found, a suitable liquid composition can be provided by using precursor substances, in particular precursor sols, which can be processed in particular by conventional printing methods, in particular ink jet printing, and can be used for the production of inorganic materials by additive manufacturing.

This allows for inorganic materials, in particular silicon carbide-containing materials, to be produced and processed in generative manufacturing methods using ink jet printing.

The use of printing processes permits an optimized and resource-saving use of materials. With the inventive method, it is thus possible to use only the amount of material actually needed to produce the desired structures in the manufacture of silicon carbide-containing structures. Consequently, it is not necessary to work with a larger surplus of material, as is usual for powder bed methods.

This is surprisingly possible through the fact that suitable precursor materials are deposited in an in particular liquid solution or dispersion, in particular a sol, by means of printing processes and then are selectively converted to the desired silicon carbide-containing materials by the effect of energy.

In the context of the present invention, a silicon carbide-containing compound is a binary, ternary or quaternary inorganic compound whose molecular formula contains silicon and carbon. In particular, a compound containing silicon carbide does not contain any molecularly bound carbon, such as carbon monoxide or carbon dioxide; rather, the carbon is present in a solid structure.

In the context of the present invention, a silicon carbide-containing structure is in particular a two- or three-dimensional structure. The two-dimensional structures are characterized by the fact that they extend almost exclusively in two spatial directions, i.e. in one plane, while the extension in the third spatial direction is negligible compared to the extension in the other two spatial directions. Such two-dimensional structures are particularly suitable for use in semiconductor technology and are often formed from doped silicon carbides. Of particular interest, however, are also finely structured three-dimensional semiconductor components made of solid silicon carbide, which are accessible using the inventive method.

The three-dimensional structures are in particular three-dimensional objects or bodies, which generally consist of silicon carbide containing high-performance ceramics or silicon carbide alloys.

The inventive method thus allows the production of materials and detailed filigree structures for semiconductor technology as well as the production of thermally and mechanically extremely robust and resilient three-dimensional objects or bodies.

One advantage of the inventive method is that by varying the precursor materials it is possible to access materials for semiconductor technology as well as mechanically and thermally extremely resistant materials using the same method. In particular, the method according to the invention allows the simultaneous use of different precursor sols when using the ink jet printing method, so that the electrical and mechanical properties of the re-suiting silicon carbide-containing structures can be selectively adjusted in certain areas.

In the context of the present invention, a carbon- and silicon-containing solution or dispersion means a solution or dispersion, in particular a precursor sol, which comprises chemical compounds that contain carbon and silicon, wherein the individual compounds can contain carbon and/or silicon. The compounds containing carbon and silicon are preferably suitable as precursors for the target compounds to be produced.

In the context of the present invention, a precursor is a chemical compound or a mixture of chemical compounds which react by chemical reaction and/or under the effect of energy to form one or more target compounds.

In the context of the present invention, a precursor sol is a solution or dispersion of precursors, in particular starting compounds, which react to the desired target compounds.

The precursor sol does not necessarily contain chemical compounds or mixtures of chemical compounds in the form originally used, but rather as hydrolysates, condensates or other reaction or intermediate products. This is particularly expressed by the term “sol”. In sol-gel processes, inorganic materials are usually converted by hydrolysis or solvolysis into reactive intermediates or agglomerates and particles, the so-called sol, which then age to a gel, in particular by condensation reaction, resulting in larger particles and agglomerates in the solution or dispersion. The physical properties of the sol or gel can be adjusted in such a way that it can be processed in conventional printing methods by selecting a suitable concentration or by adding or dispensing with reactor accelerators and catalysts. In the context of the present invention, a precursor sol can therefore also mean gel. As already explained above, agglomeration can be controlled by suitable selection of the conditions in the solution or dispersion in such a way that the agglomerates of the sol or gel particles feature particle sizes in a size range that makes processing with printing methods possible.

In the context of the present invention, a SiC precursor sol is a sol, in particular a solution or dispersion, which contains chemical compounds or their reaction products, from which silicon carbide-containing materials can be obtained under the inventive process conditions.

In the context of the present invention, a solution is to be understood as a conventional liquid single-phase system in which at least one substance, in particular a compound or its building blocks, such as ions, are homogeneously distributed in another substance, the so-called solvent. In the context of the present invention, a dispersion is to be understood as an at least biphasic system, in which a first phase, namely the dispersed phase, is distributed in a second phase, the continuous phase. The continuous phase is also referred to as the dispersion medium; the continuous phase in the present invention is usually in the form of a liquid and dispersions are therefore generally solid-liquid dispersions in the present invention. Particularly in the case of sols or polymeric compounds, the transition from a solution to a dispersion is often fluid and it is no longer possible to clearly distinguish between a solution and a dispersion.

In the context of the present invention, a layer of carbon- and silicon-containing solution or dispersion or a layer of silicon carbide-containing material means the distribution of material with a certain layer thickness on one plane, in particular a sectional plane through the structure to be produced. The plane does not have to be completely covered with the material. Usually, the layer or film is not applied continuously to the plane, but only in the areas where the silicon carbide-containing structure, including any supporting structures, is to be created. By applying a layer of the carbon- and silicon-containing solution or dispersion or a layer of the silicon carbide-containing structure, planes, in particular section planes, are defined by the structure so that a layer-wise construction of the structure is possible.

In addition, the inventive method allows not only the layer-wise construction of structures, in particular three-dimensional objects, which is usual for generative manufacturing methods, but also the addition, i.e. the adding of extra materials at almost any desired position of the three-dimensional structure, provided that the carrier plate of the construction field for production of the structure or the nozzles for application of the precursor sol or the energy source can be rotated or tilted and moved appropriately.

As explained above, the inventive method is suitable for producing a wide range of silicon carbide-containing compounds.

Usually the silicon carbide-containing compound is selected from silicon carbide, non-stoichiometric silicon carbides, doped silicon carbides and silicon carbide alloys.

In the context of the present invention, a non-stoichiometric silicon carbide compound is a silicon carbide which does not contain carbon and silicon in a molar ratio of 1:1, but in different proportions. Usually, a non-stoichiometric silicon carbide, within the scope of the present invention, shows a molar excess of silicon.

A doped silicon carbide is a silicon carbide which contains silicon and carbon either in stoichiometric or non-stoichiometric quantities, but which is doped with further elements, in particular from the 13th and 15th group of the Periodic Table of the Elements, in small quantities. The doping of the silicon carbides exerts a decisive influence on the electrical properties of the silicon carbides in particular, so that doped silicon carbides are particularly suitable for applications in semiconductor technology. Preferably in the context of the present invention, a doped silicon carbide is a stoichiometric silicon carbide of the chemical formula SiC, which has at least one doping element in the ppm (parts per million) or ppb (parts per billion) range.

Silicon carbide alloys, in the context of this invention, are compounds of silicon carbide with metals, such as titanium or other compounds, such as zirconium carbide or boron nitride, which contain silicon carbide in varying and strongly fluctuating proportions. Silicon carbide alloys often form high-performance ceramics, which are characterized by special hardness and temperature resistance.

The inventive method can therefore be used universally and is suitable for the production of a large number of different silicon carbide compounds.

If a non-stoichiometric silicon carbide is produced within the scope of the present invention, the non-stoichiometric silicon carbide is usually a silicon carbide of the general formula (I)

SiC₁₋ₓ (I)

with
x=0.05 to 0.8, in particular 0.07 to 0.5, preferably 0.09 to 0.4, preferably 0.1 to 0.3.

Such silicon-rich silicon carbides have a particularly high mechanical load-bearing capacity and are suitable for a variety of applications as ceramics.

In the context of the present invention, it may also be provided that the non-stoichiometric silicon carbide is doped, in particular with the following elements.

If, in the context of the present invention, the silicon carbide-containing compound is a doped silicon carbide, the silicon carbide is usually doped with an element selected from the group of nitrogen, phosphorus, arsenic, antimony, boron, aluminium, gallium, indium and their mixtures. Preferably the silicon carbide is doped with elements of the 13th and 15th group of the Periodic Table of the Elements, permitting in particular the specific manipulation and adjustment of the electrical properties of the silicon carbide. Such doped silicon carbides are particularly suitable for applications in semiconductor technology. As already mentioned above, the doped silicon carbide can be a stoichiometric silicon carbide or a non-stoichiometric silicon carbide, with the doping of stoichiometric silicon carbides being preferred as these are increasingly used in semiconductor technology.

If the silicon carbide is to be doped with nitrogen, nitric acid, ammonium chloride or melamine, for example, can be used as doping reagents. In the case of nitrogen, it is also possible to carry out the method for the production of silicon carbide in a nitrogen atmosphere, in which case doping with nitrogen can also be achieved, although this is less precise.

In addition, doping with alkali metal nitrates, for example, can also be achieved, although due to the alkali metals which remain in the precursor granulate, such doping is less preferred.

If a doping with phosphorus is to be carried out, it has proven to be successful if a doping with phosphoric acid is carried out.

If doping with arsenic or antimony is to be carried out, it has proven successful if the doping reagent is selected from arsenic trichloride, antimony chloride, arsenic oxide or antimony oxide.

If aluminium is to be used as a doping agent, aluminium powder can be used as a doping reagent, particularly at acidic or basic pH values. In addition, it is also possible to use aluminium chlorides. In general, when using metals as doping elements, it is always possible to use chlorides, nitrates, acetates, acetylacetonates, formates, alkoxides and hydroxides—with the inclusion of poorly soluble hydroxides.

If boron is used as a doping element, the doping reagent is usually boric acid.

If indium is used as doping element, the doping reagent is usually selected from indium halides, in particular indium trichloride (InCl₃).

If gallium is used as the doping element, the doping reagent is usually selected from gallium halides, in particular GaCl₃.

If in the context of the present invention a doped silicon carbide is produced, it has proven successful if the doped silicon carbide contains the doping element in amounts of 0.000001 to 0.0005 wt %, in particular 0.000001 to 0.0001 wt. %, preferably 0.000005 to 0.0001 wt. %, more preferably 0.000005 to 0.00005 wt. %, based on the doped silicon carbide. For the targeted adjustment of the electrical properties of the silicon carbide, extremely small amounts of doping elements are therefore completely sufficient.

If the silicon carbide-containing compound produced in the context of this invention is a silicon carbide alloy, the silicon carbide alloy is usually selected from MAX phases, alloys of silicon carbide with elements, in particular metals, and alloys of silicon carbide with metal carbides and/or metal nitrides. Such silicon carbide alloys contain silicon carbide in varying and strongly fluctuating proportions. In particular, silicon carbide may be the main component of the alloys. However, it is also possible that the silicon carbide alloy contains only small amounts of silicon carbide.

Usually, the silicon carbide alloy contains silicon carbide in quantities of 10 to 95 wt. %, in particular 15 to 90 wt %, preferably 20 to 80 wt. %, relative to the silicon carbide alloy.

In the context of this invention, MAX phases are in particular carbides and nitrides crystallizing in hexagonal layers of the general formula Mₙ₊₁AXₙ with n=1 to 3. M represents an early transition metal from the third to sixth group of the Periodic System of the Elements, while A represents an element from the 13th to 16th group of the Periodic System of the Elements. X is either carbon or nitrogen. In the context of the present invention, however, only such MAX phases are of interest whose empirical formula contains silicon carbide (SiC), i.e. silicon and carbon.

MAX phases often exhibit unusual combinations of chemical, physical, electrical and mechanical properties because they exhibit both metallic and ceramic behaviour depending on the conditions. This includes, for example, high electrical and thermal conductivity, high resistance to thermal shock, very high hardness and low coefficients of thermal expansion.

If the silicon carbide alloy is a MAX phase, it is preferred if the MAX phase is selected from Ti₄SiC₃ and Ti₃SiC.

In particular, the MAX phases mentioned above are highly resistant to chemicals and oxidation at high temperatures in addition to the properties already described.

If the silicon carbide-containing compound is an alloy of silicon carbide, it has been proven effective if the alloy is selected from alloys of silicon carbide with metals from the group of Al, Ti, V, Cr, Mn, Co, Ni, Zn, Zr and mixtures thereof.

If the alloy of silicon carbide is selected from alloys of silicon carbide with metal carbides and/or nitrides, it has been proven successful if the alloys of silicon carbide with metal carbides and/or nitrides are selected from the group of boron carbides, in particular B₄C, chromium carbides, in particular Cr₂C₃, titanium carbides, in particular TiC, molybdenum carbides, in particular Mo₂C, niobium carbides, in particular NbC, tantalum carbides, in particular TaC, vanadium carbides, in particular VC, zirconium carbides, in particular ZrC, tungsten carbides, in particular WC, boron nitrides, in particular BN, and mixtures thereof.

In the context of the present invention, particularly good results are obtained if the carbon- and silicon-containing solution or dispersion, in particular the SiC precursor sol, is applied to the substrate with a layer thickness in the range of from 0.1 to 250 μm, in particular from 0.2 to 100 μm, preferably from 0.5 to 50 μm, more preferably from 1 to 25 μm. With the aforementioned layer thicknesses, silicon carbide-containing structures can be obtained both for semiconductor applications and in the form of three-dimensional objects or bodies.

In the context of the present invention, particularly good results are obtained if the carbon- and silicon-containing solution or dispersion, in particular the SiC precursor sol, is applied to the substrate by a coating method.

In the context of this invention, a substrate means any underlying material, in particular a carrier plate of the construction field or a part or layer of the silicon carbide-containing structure, to which the carbon- and silicon-containing solution or dispersion, in particular the SiC precursor sol, is applied. In the context of the present invention, it is therefore usually intended that the substrate is a carrier material or a part, in particular a layer, of the silicon carbide-containing structure. The carrier material is usually a carrier plate on which the first layer of the structure to be produced or a supporting structure is produced. However, the substrate can also be a highly complex structure consisting of silicon carbide-containing material or other suitable materials to which silicon carbide-containing materials are to be applied.

As far as the coating method is concerned, this can be selected from any suitable method. Usually the coating method is selected from rotary coating, dip coating, spray application and printing methods, in particular inkjet printing. If the layer thickness is sufficient and a liquid with a high surface tension is used, diffuse fine droplet spraying is also conceivable, resulting in a smooth surface.

Particularly good results are obtained in this context if the coating method is an ink jet printing method, i.e. the carbon- and silicon-containing solution and dispersion is applied to the substrate by ink jet printing. The use of ink-jet printing processes allows in particular a high-resolution and locally sharply limited application of the carbon- and silicon-containing solution, in particular of the SiC precursor sol, with simultaneous low material input, so that even filigree structures are accessible for semiconductor applications.

Inkjet printing processes are divided into processes that work with a continuous ink jet (continuous ink jet, CIJ) and processes in which individual droplets are specifically separated from the nozzles of the printer, the so-called drop on demand (DOD) process. In the continuous ink jet process, the continuous ink jet is usually broken down into individual droplets by a piezo-electric oscillator, which are then electrically charged and directed onto the substrate via deflection electrodes, whereby excess printing fluid is collected directly at the print head. This process also works with a certain excess of precursor sol.

In the context of the present invention, it is preferred if so-called drop-on-demand processes or printers are used. In drop-on-demand processes, only the drops of liquid are produced which are actually applied to the substrate. Usually the drop-on-demand process is a bubble-jet process or a piezo printing process.

The bubble-jet process is a printing process in which a volume of liquid in the nozzle is heated abruptly to form a bubble of gaseous solvent or dispersant which presses the remainder of the pressurized liquid, in particular a precursor sol, out of the nozzle. In the piezo printing process, liquids are mechanically pressed out of the nozzle by applying a voltage using an inverse piezoelectric effect. In the context of the present invention, the piezo printing process is preferred in particular, since the properties of the carbon- and silicon-containing liquid, in particular of the SiC precursor sol, should remain constant, i.e. the viscosities and concentration ratios should not change, which inevitably occurs during the execution of the bubble jet process due to the transition of part of the solvent or dispersion agent into the gas phase.

In the context of the present invention, particularly good results are obtained if the carbon- and silicon-containing solution or dispersion, in particular the SiC precursor sol, is printed by ink jet, preferably using the drop-on-demand method, with a resolution of 40 to 10,000,000,000 drops/cm², in particular 2,500 to 400,000,000 drops/cm², preferably 10,000 to 100,000,000 drops/cm², more preferably 40,000 to 25,000,000 drops/cm².

Similarly, in the context of the present invention, it is preferred if the carbon- and silicon-containing solution or dispersion, in particular the SiC precursor sol, is applied by ink-jet printing, preferably as drop-on-demand process, with a drop diameter of 0.1 to 500 μm, in particular 0.5 to 200 μm, preferably 1 to 100 μm, more preferably 2 to 50 μm. Within the scope of the present invention, it is thus possible to achieve very fine resolutions when applying the carbon- and silicon-containing solution or dispersion, in particular the SiC precursor sol, thus also enabling filigree structures for semiconductor applications and detailed, high-resolution contours for ceramic components.

Since the printing speed depends on the droplet size and the use of different carbon-containing and silicon-containing solutions or dispersions, in particular precursor sols, which can lead to different layer densities of the resulting SiC compounds in a workpiece, it may be advisable to work on a workpiece with different droplet sizes. In particular, it may be advisable to first fill a surface with relatively large droplets and then use small droplet sizes to produce surfaces that are as smooth as possible. For this purpose, the apparatus may have to be equipped with spreading means, in particular nozzles, for different drop sizes. It can also be advantageous to use electromagnetic radiation with different effective ranges, in particular laser beams with different diameters.

If, as described above, larger droplets are first used to produce rough surfaces, which are then to be compensated by small droplets, it is necessary to measure the effective quality of the surface in order to be able to produce a specific compensation. This can be done on a small scale with short-term feedback for application and radiation. A measurement of the surface can also be used for quality control or repairs at μm level. For this purpose, a laser scanner can be mounted in the immediate vicinity of the radiation laser. Altogether, a “digital twin” of the workpiece is intended to be permanently updated with the help of the measurement.

In the context of the present invention, it is possible that the carbon- and silicon-containing solution or dispersion, in particular the SiC precursor sol, is applied to the substrate over the entire surface or locally, in particular regioselectively. In the context of the present invention, it is thus possible, in particular if the silicon carbide-containing structure to be produced consists of only one layer, to apply a film of the carbon- and silicon-containing solution or dispersion, in particular of the SiC precursor sol, to a carrier medium and to then generate the silicon carbide-containing structure by spatially resolved radiation of energy. In the context of the present invention, however, it is preferred if already the carbon- and silicon-containing solution or dispersion, in particular the SiC precursor sol, is applied locally, i.e. regioselectively. In this way, starting materials can be saved and the inventive process management becomes significantly more efficient and cost-effective.

In the context of the present invention, it is also preferred if the carbon- and silicon-containing solution or dispersion, in particular the SiC precursor sol, is applied via one or more, preferably several, spreading means, in particular nozzles. By applying the carbon- and silicon-containing solution or dispersion, in particular the SiC precursor sol, via several spreading means, in particular nozzles, the process speed of the method according to the invention can be significantly increased. In addition, by applying different precursor sols using the individual spreading means, in particular nozzles, it is possible to obtain a composite material or a component whose electrical and mechanical property can be specifically adjusted in certain areas.

In accordance with a preferred embodiment of the present invention, the invention relates to a method for the production of a silicon carbide-containing structure, in particular by additive manufacturing, as previously described, wherein
(a) in a first method step, a layer of a carbon- and silicon-containing solution or dispersion, in particular of a SiC precursor sol, is applied to a substrate, and
(b) in a second method step following the first method step (a), the layer of the carbon- and silicon-containing solution or dispersion, in particular at least in some areas, is converted by the effect of energy into a silicon carbide-containing compound, so that a layer of the silicon carbide-containing structure is produced,
   wherein the method steps (a) and (b) are repeated until the silicon carbide-containing structure is obtained.

All the above features and advantages of the more general embodiments of the present invention described above may also be applied to this preferred embodiment of the present invention. In particular, all previously mentioned definitions apply to these embodiments.

According to these embodiments of the present invention, three-dimensional structures, in particular three-dimensional objects or bodies, are often obtained by the layer-wise manufacturing typical for generative manufacturing methods. Superimposed structures are obtained either by a suitable adjustment of the viscosity of the carbon- and silicon-containing solution or dispersion, especially of the SiC precursor sol, or with the aid of supporting structures.

In particular, the structure to be produced, in particular a three-dimensional object or body, is digitized by means of a CAD program and divided into layers, which are subsequently successively produced by means of additive manufacturing, in particular by means of the method according to the invention, so that finally the desired silicon carbide-containing structure or the silicon carbide-containing three-dimensional object or the silicon carbide-containing body results.

Furthermore, in accordance with this embodiment of the present invention, it is intended in particular that the layer thickness of the carbon- and silicon-containing solution or dispersion, in particular of the SiC precursor sol, has a range from 0.1 to 250 μm, in particular from 0.2 to 100 μm, preferably from 0.5 to 50 μm, more preferably from 1 to 25 μm.

Similarly, in accordance with this embodiment of the present invention, it is intended that the layer of the carbon- and silicon-containing solution or dispersion, in particular of the SiC precursor sol, is applied to the substrate by a coating process.

Suitable coating processes, as described above, are rotary coatings, dip coatings and printing processes, in particular the ink jet printing process.

In accordance with a preferred embodiment of the present invention, the layer of the carbon- and silicon-containing solution or dispersion, in particular of the SiC precursor sol, is printed by ink-jet printing, preferably as drop-on-demand process, with a resolution of 400 to 10,000,000,000 drops/cm², in particular 2,500 to 400,000,000 drops/cm², preferably 10,000 to 100,000,000 drops/cm², more preferably 40,000 to 25,000,000 drops/cm².

Similarly, it may be provided that the layer of the carbon- and silicon-containing solution or dispersion, in particular of the SiC precursor sol, is applied to the substrate by ink-jet printing, preferably as drop-on-demand process, with a drop diameter of 0.1 to 500 μm, in particular 0.5 to 200 μm, preferably 1 to 100 μm, more preferably 2 to 50 μm.

In addition, it is also possible that the layer of the carbon- and silicon-containing solution or dispersion, in particular of the SiC precursor sol, may be applied to the substrate over the entire surface or locally, in particular regioselectively.

In accordance with this embodiment of the present invention, the layer of the carbon- and silicon-containing solution or dispersion, in particular of the SiC precursor sol, is also preferably applied to the substrate by means of one or more, preferably several, spreading means, in particular nozzles.

In the context of the present invention, it is usually intended that the carbon- and silicon-containing solution or dispersion, in particular the SiC precursor sol, is heated to temperatures in the range of from 1,600 to 2,100° C., in particular from 1,700 to 2,000° C., preferably from 1,700 to 1,900° C., at least in some areas, by the effect of energy. At these temperatures, decomposition, i.e. cleavage of the individual components of the silicon- and carbon-containing solution or dispersion, in particular of the SiC precursor sol, and transfer of the cleavage products into the gas phase is effected, so that in the gas phase reactive silicon and carbon atoms as well as, if necessary, other alloy constituents and doping elements are present, which, in the immediate vicinity of their point of origin, reassemble to form the desired silicon carbide-containing compound again, so that defined and locally limited silicon carbide-containing structures can be obtained. Silicon carbide and its compounds can crystallize in a large number of polytypes with slightly different properties at the same stoichiometry. The temperature (and, if necessary, the heating process) can be used to determine which polytype is formed.

According to a preferred embodiment of the present invention, it is intended that in method step (b) the effect of energy is limited in time. A time limitation of the energy effect ensures that the desired silicon carbide-containing compound is deposited in the immediate vicinity of the place where the energy is applied and does not travel further distances in the gas phase. This would prevent the formation of defined compact structures from silicon carbide-containing compounds. In particular, the present invention provides that only reaction products of the precursor sol, which are not required to build up the silicon carbide-containing structure, remain permanently in the gas phase. These reaction products are preferably stable compounds, such as CO₂, H₂O, etc., which remain in the gas phase and can be removed so that only the desired pure silicon carbide-containing compound is produced regioselectively and locally.

In the context of the present invention, it is advantageously intended that in the second method step (b) the effect of energy is achieved by electro-magnetic radiation, in particular by laser radiation. In this way, locally sharply limited, very high temperatures can be produced quickly and briefly in the carbon- and silicon-containing solution or dispersion applied to the substrate, so that the precursor compounds are immediately cleaved and can react with the target compounds, but can precipitate almost instantaneously again at the site where the energy exposure took place as the silicon carbide-containing target compound.

In accordance with a particularly preferred embodiment of the present invention, the energy effect, in particular by means of electromagnetic radiation, is locally limited, in particular regioselective.

Within the scope of the present invention, it may also be provided that the electromagnetic radiation has an effective range of 0.1 to 1,000 μm, in particular 0.5 to 500 μm, preferably 1 to 200 μm, more preferably 2 to 100 μm. In the context of this invention, the effective range of electromagnetic radiation is understood to be the smallest range of simultaneous radiation on the substrate. In the case of laser beams, this corresponds in particular to the cross-section or diameter of the laser beam when it hits the substrate or to the smallest expansion of the radiation on the substrate resulting from the use of masks. The larger the range which is at minimum covered by the electromagnetic radiation, the lower the resolution of the electromagnetic radiation.

According to one preferred embodiment of the present invention, the electromagnetic radiation has an effective range which is larger than the droplet diameter of the carbon- and silicon-containing solution or dispersion. In this way, it is ensured that even with very fine-particle structures, which only exhibit an expansion corresponding to a drop width of the carbon- and silicon-containing solution or dispersion, a complete conversion to the silicon carbide-containing compound takes place. Although it is also possible to work with electromagnetic radiation whose effective range is smaller than the drop diameter of the carbon- and silicon-containing solution or dispersion, excess carbon- and silicon-containing solution or dispersion is always to be removed here if the width of the energy effect only corresponds to the effective range.

Particularly good results are obtained in this context if the effective range of the electromagnetic radiation is a multiple of the droplet diameter. In this context it is preferred if the effective range of the electromagnetic radiation is 101 to 1,000%, in particular 102 to 800%, preferably 105 to 700%, of the drop diameter of the solution or dispersion containing carbon and silicon.

According to a preferred embodiment of the present invention, it is intended that the effective range of electromagnetic radiation is 101 to 150%, in particular 102 to 120%, preferably 105 to 115%, of the drop diameter of the carbon- and silicon-containing solution or dispersion. It is particularly preferable in this context if the effective range of electromagnetic radiation is 110% of the droplet diameter of the carbon- and silicon-containing solution or dispersion.

As regards the viscosity of the carbon- and silicon-containing solution or dispersion, in particular of the SiC precursor sol, this can vary widely depending on the application conditions and the structures to be produced.

However, it has proven successful if the carbon- and silicon-containing solution or dispersion, in particular the SiC precursor sol, has a dynamic viscosity according to Brookfield at 25° C. in the range of from 3 to 500 mPas, in particular from 4 to 200 mPas, preferably from 5 to 100 mPas. In the context of the present invention, it is therefore preferred to use highly viscous carbon- and silicon-containing liquids, which are, however, suitable for spray or pressure application, since in this way also overhanging structures are accessible to a certain extent without supporting structures.

In accordance with a preferred embodiment of the present invention, it is possible that several different carbon and silicon-containing solutions or dispersions, in particular SiC precursor sols, are used in method step (a). In this way, silicon carbide-containing structures can be obtained whose mechanical and electrical properties can be specifically adjusted. In particular, mechanically stressed zones of ceramic components, for example, can be specifically reinforced or conductive tracks can be generated in a component.

Furthermore, in accordance with this preferred embodiment of the present invention, it can be provided that in method step (a) the different carbon- and silicon-containing solutions or dispersions, in particular the SiC precursor sols, are applied to the substrate using different spreading means, in particular nozzles. The use of several, in particular different spreading means, in particular nozzles, for the application of the different carbon- and silicon-containing solutions or dispersions enables a very fast production of individual layers of a silicon carbide-containing structure with different electrical or mechanical properties in individual partial areas of the structure.

According to a particular embodiment of the present invention, it may further be provided that at least one carbon- and/or silicon-free solution or dispersion, in particular a precursor sol, is used in method step (a). By using such carbon- and/or silicon-free solutions or dispersions, especially precursor sols, it is possible, for example, to introduce other materials into the silicon carbide-containing structures in a targeted manner or to adjust the interfacial properties of silicon carbide-containing materials in a targeted manner.

The composition of this carbon- and/or silicon-free solution or dispersion is described in more detail in the following description of carbon- and silicon-containing solutions and dispersions.

In this context, it may in particular be provided that in method step (a) the carbon- and/or silicon-free solution or dispersion, in particular the precursor sol, is applied to the substrate using spreading means, in particular nozzles. In this context, it may also be provided that other spreading means, in particular nozzles, are used for the application of the carbon- and/or silicon-free solution or dispersion, in particular the precursor sol, than for the application of the carbon- and silicon-containing solution(s) or dispersion(s). In the context of the present invention, a different spreading means or a different nozzle does not necessarily refer to a differently designed, i.e. differently constructed, spreading means, but usually to a spreading means which is just not used for the spreading or application of the silicon- and carbon-containing solution or dispersion. In the context of this invention, it is also preferred if the carbon- and/or silicon-free solution or dispersion is applied to the substrate together with the carbon- and silicon-containing solutions or dispersions by printing.

As far as the viscosity of the carbon- and/or silicon-free solution or dispersion is concerned, this can also vary widely. However, it has proven successful if the carbon- and/or silicon-free solution or dispersion has comparable viscosities to the carbon- and silicon-containing solution or dispersion. Particularly good results are obtained in this context, if the carbon- and/or silicon-free solution or dispersion, in particular the precursor sol, has a dynamic viscosity according to Brookfield at 25° C. in the range of from 3 to 500 mPas, in particular from 4 to 200 mPas, preferably from 5 to 100 mPas.

In accordance with a preferred embodiment of the present invention, the solution or dispersion of the carbon- and silicon-containing solution or dispersion, in particular the precursor sol, is produced on the substrate. In accordance with this particular preferred embodiment of the present invention, the solution or dispersion, in particular the precursor sol, is thus produced in situ on the substrate. In this case, the individual components of the silicon- and carbon-containing solution or dispersion, in particular the precursor sol, may be stored in the form of separate solutions or dispersions and applied to the substrate via suitable spreading means, so that the silicon- and carbon-containing solution or dispersion, in particular the precursor sol, is formed just on the substrate.

However, it may also be provided that the individual components of the carbon- and silicon-containing solution or dispersion, in particular of the precursor sol, are mixed immediately before application of the carbon- and silicon-containing solution or dispersion, in particular of the precursor sol, in particular in a mixing device intended for this purpose. By using the individual components of the carbon- and silicon-containing solution or dispersion, in particular the precursor sol, a large number of different silicon carbide-containing compounds can be produced from a limited selection of starting materials or starting material solutions or dispersions.

In the context of the present invention, it is generally intended that at least method step (b) is carried out in a protective gas atmosphere, in particular an inert gas atmosphere. By carrying out the process in a protective gas atmosphere, in particular an inert gas atmosphere, it is prevented that in particular the carbon-containing compound is oxidized in the presence of oxygen, i.e. burns. Preferably, the entire process, i.e. both method step (a) and method step (b), is carried out in a protective gas atmosphere, in particular an inert gas atmosphere.

In the context of the present invention, a protective gas is a gas which effectively prevents the oxidation of the components of the carbon- and silicon-containing solution or dispersion by atmospheric oxygen in particular, while an inert gas in the context of the present invention is a gas which does not react with the components of the carbon- and silicon-containing solution or dispersion under process conditions. For example, nitrogen can be used as a protective gas in this invention, but not as an inert gas, since gaseous nitrogen can be incorporated into the silicon carbide structure, particularly in the form of nitrides. If, however, doping with nitrogen is desired, it is also possible to carry out the method according to the invention in a nitrogen atmosphere.

In the context of the present invention, the protective gas is usually selected from noble gases and nitrogen and their mixtures, in particular argon and nitrogen and their mixtures. It is particularly preferred in the context of this invention if the protective gas is argon.

The figures show according to

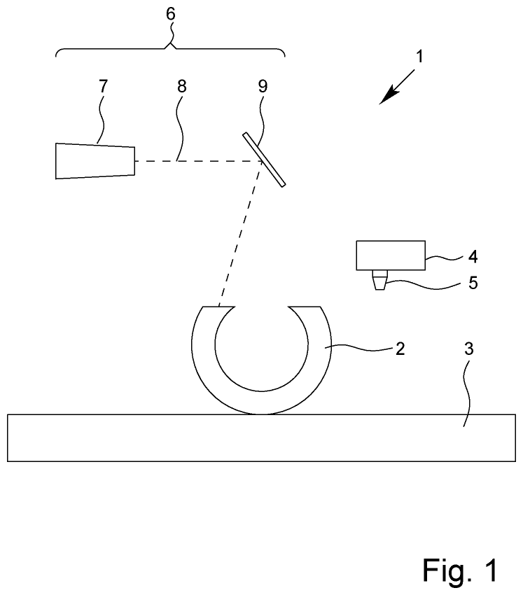

FIG. 1 a cross section through an inventive apparatus along an xz plane,

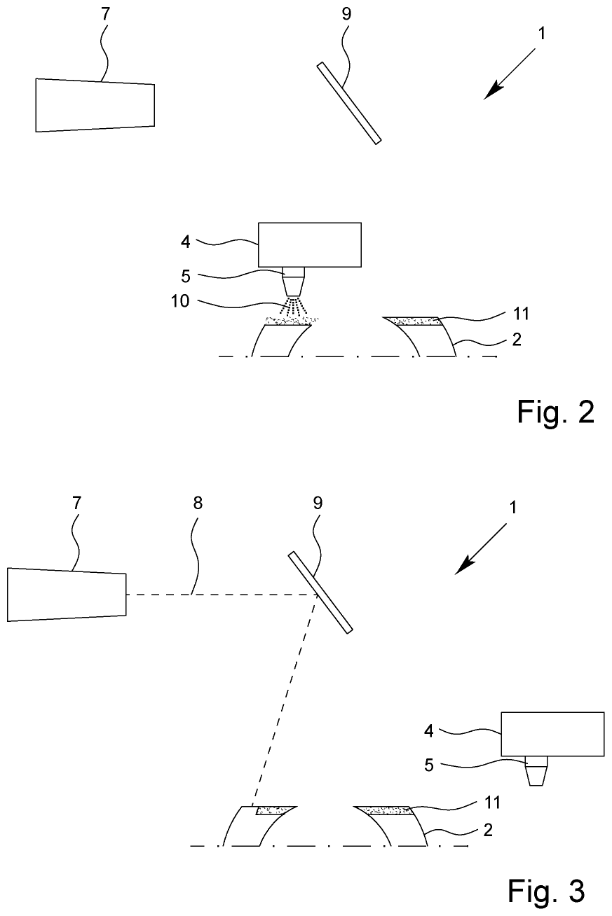

FIG. 2 an enlarged section from FIG. 1, in which the carbon- and silicon-containing solution or dispersion is applied to a substrate,

FIG. 3 also an enlarged section of FIG. 1, in which a layer of a carbon- and silicon-containing solution or dispersion applied to a substrate is converted to silicon carbide by laser radiation,

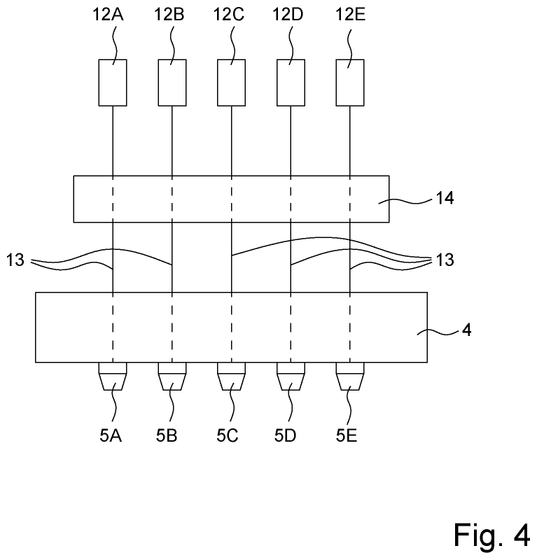

FIG. 4 an arrangement of storage devices for receiving and dispensing precursor sols or components of precursor sols and spreading means for applying a solution or dispersion,

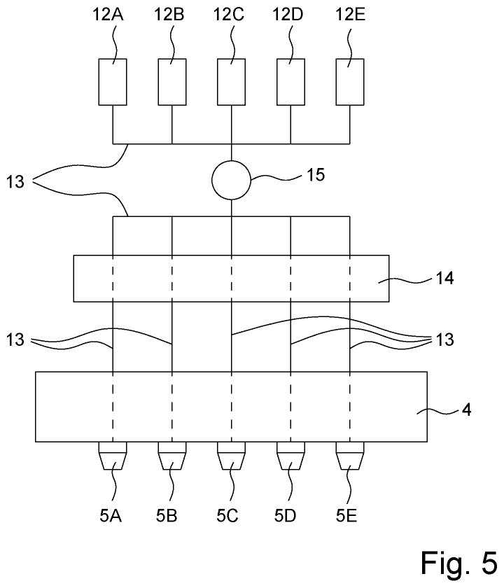

FIG. 5 an alternative arrangement of storage devices for receiving and dispensing precursor sols or their components and spreading means for applying the solution or dispersion and

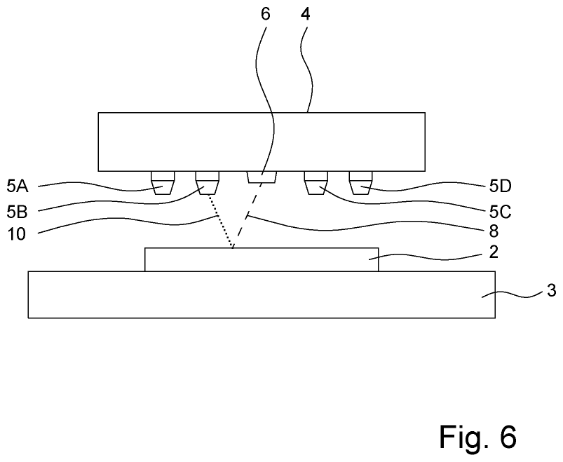

FIG. 6 a preferred embodiment of the present invention, in which both spreading means for applying a solution or dispersion to a substrate and means for directing radiation are arranged on a discharge device.

Further subject-matter of the present invention—according to a second aspect of the present invention—is a silicon carbide-containing structure, obtainable according to the procedure described above.

As explained above, the silicon carbide-containing structure can be a two-dimensional structure, e.g. a conductor track, or a three-dimensional structure, i.e. a three-dimensional object or body.

For further details on this aspect of the invention, reference is made to the above explanations on the inventive method, which apply accordingly to the silicon carbide-containing structure.

Again further subject-matter of the present invention—according to a third aspect of the present invention—is a composition, in particular a SiC precursor sol, in the form of a solution or dispersion, containing

(A) at least one silicon-containing compound,
(B) at least one carbon-containing compound,
(C) at least one solvent or dispersant; and
(D) optionally, doping and/or alloying reagents.

As regards the selection of the solvent or dispersant in the composition in accordance with the invention, this can then be selected from all suitable solvents or dispersants. Usually, however, the solvent or dispersant is selected from water and organic solvents and mixtures thereof. In particular in mixtures containing water, the usually hydrolysable or solvolysable starting compounds are converted to inorganic hydroxides, in particular metal hydroxides and silicas, which then condense so that precursor sols suitable for printing processes are obtained from which silicon carbide-containing compounds can be produced.

The compounds used should also have sufficiently high solubilities in the solvents used, in particular in ethanol and/or water, in order to be able to form finely divided dispersions or solutions, in particular sols, and should not react with other constituents of the solution or dispersion, in particular sol, forming insoluble compounds during the production method. In addition, the reaction rate of the individual reactions is to be adjusted to each other, since hydrolysis, condensation and especially gelation should possibly take place undisturbed in order to obtain a homogeneous distribution of the individual components in the sol or gel. The reaction products formed should not be sensitive to oxidation and should not be volatile.

In the context of the present invention, it may also be provided that the organic solvent is selected from alcohols, in particular methanol, ethanol, 2-propanol, acetone, ethyl acetate and mixtures thereof. It is particularly preferred in this context if the organic solvent is selected from methanol, ethanol, 2-propanol and their mixtures, with ethanol being preferred in particular.

The organic solvents mentioned above can be mixed with water in a wide range and are particularly suitable for dispersing or dissolving polar inorganic substances such as metal salts.

As already mentioned above, mixtures of water and at least one organic solvent, in particular a mixture of water and ethanol, are preferably used as solvents or dispersion agents within the scope of the present invention. In this context, it is preferred if the solvent or dispersant has a weight-related ratio of water to organic solvent of 1:10 to 20:1, in particular 1:5 to 15:1, preferably 1:2 to 10:1, more preferably 1:1 to 5:1, particularly preferred 1:3. Through the ratio of water to organic solvent, on the one hand the hydrolysis rate, in particular of the silicon-containing compound and of the doping and alloying reagents, can be adjusted, on the other hand the solubility and reaction rate of the carbon-containing compound, in particular of the carbon-containing precursor compounds, such as sugar, can also be adjusted.

The quantity in which the composition contains the dissolving or dispersing agent can vary over a wide range depending on the respective application conditions and the type of silicon carbide-containing compound to be produced, as described below. Usually, however, the composition contains the solvent or dispersant in quantities of 10 to 80 wt. %, in particular 15 to 75 wt. %, preferably 20 to 70 wt. %, more preferably 20 to 65 wt. %, based on the composition.

As far as the silicon-containing compound is concerned, it is preferred if the silicon-containing compound is selected from silanes, silane hydrolysates, orthosilicic acid and mixtures thereof, in particular silanes. In the context of the present invention, orthosilicic acid and its condensation products can, for example, be obtained from alkali silicates whose alkali metal ions have been exchanged for protons by ion exchange. As far as possible, alkali metal compounds are not used in compositions of the present invention, since they are also incorporated into the silicon carbide-containing compound. Alkalimetal doping, however, is generally not desired within the scope of the present invention. However, if this should be desired, suitable alkali metal salts, for example of silicon-containing compounds or also alkali phosphates, can be used.

If a silane is used as a silicon-containing compound in the context of the present invention, it has proven successful if the silane is selected from silanes of the general formula II

R₄₋ₙSiXₙ (II)

with
R=alkyl, in particular C1- to C5-alkyl, preferably C1- to C3-alkyl, more preferably C1- and/or C2-alkyl;
   aryl, in particular C6- to C20-aryl, preferably C6- to C15-aryl, more preferably C6- to C10-aryl;
   olefin, in particular terminal olefin, preferably C2- to C10-olefin, more preferably C2- to C8-olefin, in particular preferably C2- to C5-olefin, particularly C2- and/or C3-olefin, most preferably vinyl;
   amine, in particular C2- to C10-amine, preferably C2- to C8-amine, more preferably C2- to C5-amine, particularly preferably C2- and/or C3-amine;
   carboxylic acid, in particular C2- to C10-carboxylic acid, preferably C2- to C8-carboxylic acid, more preferably C2- to C5-carboxylic acid, particularly preferably C2- and/or C3-carboxylic acid;
   alcohol, in particular C2- to C10-alcohol, preferably C2- to C8-alcohol, more preferably C2- to C5-alcohol, particularly preferably C2- and/or C3-alcohol;
X=halide, in particular chloride and/or bromide;
   alkoxy, in particular C1- to C6-alkoxy, preferably C1- to C4-alkoxy, more preferably C1- and/or C2-alkoxy; and
n=1-4, preferably 3 or 4.

Particularly good results are obtained, however, when the silane is selected from silanes of the general formula IIa

R₄₋ₙSiXₙ (IIa)

with
R=C1- to C3-alkyl, in particular C1- and/or C2-alkyl;
   C6- to C15-aryl, in particular C6- to C10-aryl;
   C2- and/or C3-olefin, in particular vinyl;
X=alkoxy, in particular C1- to C6-alkoxy, preferably C1- to C4-alkoxy, more preferably C1- and/or C2-alkoxy; and
n=3 or 4.

By hydrolysis and subsequent condensation reaction of the aforementioned silanes, condensed orthosilicic acids or siloxanes can easily be obtained within the scope of the present invention, which have only very small particle sizes, with other elements, in particular metal hydroxides, also being able to be incorporated into the basic structure.

By using carbon- and silicon-containing solutions or dispersions, in particular SiC precursor sols, it is possible within the scope of the present invention to arrange the components of the silicon carbide-containing compound to be produced in a homogeneous and fine distribution spatially as adjacent as possible to each other, so that the individual components of the silicon carbide-containing target compound are present in immediate proximity to each other when energy is effected and do not first have to diffuse comparatively long distances through the gas phase. In this way, the present invention makes it possible to produce almost any silicon carbide-containing compounds by using suitable carbon- and silicon-containing solutions or dispersions, in particular SiC precursor sols.

Particularly good results are obtained in the context of the present invention if the silicon-containing compound is selected from tetraalkoxysilanes, trialkoxysilanes and mixtures thereof, preferably tetraethoxysilane, tetramethoxysilane or triethoxymethylsilane and mixtures thereof.

As far as the quantities in which the composition contains the silicon-containing compound are concerned, these can also vary widely depending on the respective conditions of use. However, the composition usually contains the silicon-containing compound in quantities of 1 to 80 wt %, in particular 2 to 70 wt %, preferably 5 to 60 wt. %, more preferably to 60 wt. %, based on the composition.

As stated above, the composition according to the invention contains at least one carbon-containing compound. All compounds which can either be dissolved in the solvents used or at least finely dispersed and can release carbon under the effect of energy, in particular under the effect of laser beams, can be considered as carbon-containing compounds. The carbon-containing compound is also preferably capable of reducing metal hydroxides to elemental metal under the method conditions.

In the context of the present invention, it has proven effective if the carbon-containing compound is selected from the group of sugars, in particular sucrose, glucose, fructose, invert sugar, maltose; starch; starch derivatives; organic polymers, in particular phenol formaldehyde resin and resorcinol formaldehyde resin, and mixtures thereof.

Particularly good results are obtained in the context of the present invention if the carbon-containing compound is selected from the group of sugars; starch, starch derivatives and mixtures thereof, preferably sugars, since the viscosity of the composition, on the one hand, and the stickiness of the composition, on the other hand, can be specifically adjusted, in particular through the use of sugars and starch or starch derivatives, so that even demanding geometries can be produced in additive manufacturing, in particular without the use of supporting structures, due to the good adhesive properties of the composition according to the invention.

In order to improve the solution or dispersion of the carbon-containing compound in the solution or dispersion, it may be intended that the carbon-containing compound, in particular selected from sugars or starches, is dissolved or predispersed in a small quantity of solvent or dispersant before the solution or dispersion is combined with the actual composition. In this context, it has proven successful if the carbon-containing compound is used in a solution or dispersion containing the carbon-containing compound in quantities of 10 to 90 wt. %, in particular 30 to 85 wt. %, preferably 50 to 80 wt. %, more preferably 60 to 70 wt. %, based on the solution or dispersion of the carbon-containing compound.

As regards the quantity in which the composition contains the carbon-containing compound, this can also vary widely depending on the respective application and application conditions or the target compounds to be produced. Usually, however, the composition contains the carbon-containing compound in quantities of 5 to 50 wt. %, in particular 10 to 40 wt. %, preferably 10 to 35 wt. %, more preferably 12 to 30 wt. %, based on the composition.

In the context of the present invention, the composition may include a doping or alloying reagent. If the composition comprises a doping or alloying reagent, the composition usually comprises the doping or alloying reagent in amounts of 0.000001 to 60 wt. %, in particular 0.000001 to 45 wt. %, preferably 0.000005 to 45 wt. %, more preferably 0.00001 to 40 wt. %, based on the solution or dispersion. The properties of the resulting silicon carbide-containing compounds can be decisively changed by the addition of doping and alloying reagents. Doping influences in particular the electrical properties of the silicon carbide-containing compound, whereas the mechanical and thermal properties of the silicon carbide-containing compounds are decisively influenced by the production of silicon carbide alloys or non-stoichiometric silicon carbides.

As already explained above, the constituents of the individual components of the composition according to the invention vary widely depending on the respective application conditions and the silicon carbide-containing compounds to be produced. This results in large differences, for example, in whether a stoichiometric, possibly doped, silicon carbide, a non-stoichiometric silicon carbide or an alloy containing silicon carbide is to be produced.

If a non-stoichiometric silicon carbide, in particular a silicon carbide with an excess of silicon, is to be produced with the composition according to the invention, the composition usually contains the silicon-containing compound in quantities of 20 to 70 wt. %, in particular to 65 wt. %, preferably 30 to 60 wt %, more preferably 40 to 60 wt %, based on the composition.

In accordance with this embodiment, it may also be provided that the composition contains the carbon-containing compound in quantities of 5 to 40 wt. %, in particular 10 to 35 wt. %, preferably 10 to 30 wt %, more preferably 12 to 25 wt %, relative to the composition.

In addition, in the case that a non-stoichiometric silicon carbide is to be prepared, it may be provided that the composition contains the solvent or dispersant in amounts of 30 to 80 wt. %, in particular 35 to 75 wt. %, preferably 40 to 70 wt. %, more preferably 40 to 65 wt. %, based on the composition.

Similarly, it has proven successful if the composition for the preparation of a doped silicon carbide contains the silicon-containing compound in quantities of 20 to 70 wt %, in particular to 65 wt. %, preferably 30 to 60 wt %, relative to the composition.

In addition, it may also be provided that the solution or dispersion according to this embodiment contains the carbon-containing compound in quantities of 5 to 40 wt. %, in particular to 35 wt %, preferably 10 to 30 wt. %, more preferably 12 to 25 wt. %, based on the composition.

In addition, it may also be intended that, in the case that a doped silicon carbide is to be prepared, the solution or dispersion contains the solvent or dispersant in quantities of 30 to 80 wt. %, in particular 35 to 75 wt. %, preferably 40 to 70 wt. %, more preferably 40 to 65 wt. %, based on the composition.

In addition, particularly good results are obtained when the composition according to this embodiment contains a doping reagent in amounts of 0.000001 to 0.5 wt %, in particular 0.000005 to 0.1 wt %, preferably 0.00001 to 0.01 wt. %, relative to the composition.

If the silicon carbide is to be doped with nitrogen, nitric acid, ammonium chloride or melamine, for example, can be used as doping reagents. In the case of nitrogen, it is also possible to carry out the generative manufacturing process in a nitrogen atmosphere, in which case doping with nitrogen can also be achieved, but is less accurate. Further doping reagents are mentioned in particular in relation to the description of the method according to the invention.

In the context of the present invention it may be that the doped silicon carbide is a stoichiometric or a non-stoichiometric silicon carbide, but preferably the doped silicon carbide is a stoichiometric silicon carbide.

If a composition for the production of a silicon carbide alloy is to be provided within the framework of the present invention, it has proven successful if the composition contains the silicon-containing compound in amounts of 1 to 80 wt %, in particular 2 to 70 wt. %, preferably 5 to 60 wt %, more preferably 10 to 30 wt. %, based on the composition.

Furthermore, it may be provided according to this embodiment that the composition contains the carbon-containing compound in quantities of 5 to 50 wt. %, in particular 10 to 40 wt. %, preferably 15 to 40 wt %, more preferably 20 to 35 wt %, based on the composition.

Similarly, according to this embodiment, it may be provided that the composition contains the solvent or dispersant in quantities of 10 to 60 wt %, in particular 15 to 50 wt. %, preferably to 40 wt %, more preferably 20 to 40 wt. %, relative to the composition.

Furthermore, according to this embodiment, it may be provided that the composition contains the alloying reagent in quantities of 5 to 60 wt %, in particular 10 to 45 wt. %, preferably to 45 wt. %, preferably 20 to 40 wt. %, relative to the composition.

In the present invention, it is particularly preferred when the alloying reagent is selected from the corresponding chlorides, nitrates, acetates, acetylacetonates and formates of the alloying elements, in particular alloying metals. The alloying element or metal is usually selected from the group consisting of Al, Ti, V, Cr, Mn, Co, Ni, Zn, Zr and mixtures thereof.

If a stoichiometric silicon carbide is to be provided within the framework of the present invention, it has proven successful if the composition contains the silicon-containing compounds in quantities of 20 to 40 wt. %, in particular 25 to 35 wt. %, preferably 30 to 40 wt. %, based on the composition.

Furthermore, it may be provided in accordance with this embodiment that the solution or dispersion contains the carbon-containing compound in quantities of 20 to 40 wt. %, in particular 25 to 40 wt. %, preferably 25 to 35 wt. %, more preferably 25 to 35 wt %, based on the composition.

It may also be provided in accordance with this embodiment that the composition contains the solvent or dispersant in quantities of 30 to 80 wt. %, in particular 35 to 75 wt %, preferably 40 to 70 wt. %, more preferably 40 to 65 wt. %, relative to the composition.

Furthermore, it is possible that the composition according to this embodiment contains a doping reagent, in particular selected from the aforementioned compounds and/or in the quantities mentioned in connection with the doped silicon carbides.

Furthermore, the present invention may provide that the composition comprises at least one additive. Particularly good results are obtained in this context if the composition contains the additive in quantities of 0.01 to 5 wt %, in particular 0.05 to 2 wt. %, preferably 0.1 to 1 wt %, relative to the composition.

If the composition contains an additive within the scope of the present invention, it has proven successful if the additive is selected in particular from thickeners, rheological adjusting agents and pH adjusting agents, in particular acids and bases.

By the addition of acids and bases, especially condensation processes in the composition, especially the precursor sol, can be influenced, so that the particle sizes of the resulting sol or gel particles can be specifically adjusted. In addition, acids and bases can also be used as catalysts for the inversion of saccharose to invert sugar.

As already mentioned above, it is possible that silicon- and/or carbon-free solutions or dispersions, especially precursor sols, are also used within the scope of the present invention. Such precursor sols are composed according to the previously described compositions, but do not contain the silicon-containing and/or carbon-containing compound, i.e. solutions or dispersions of possible alloying reagents or other element compounds are added alone, for example, in order to produce special properties in the resulting silicon carbide-containing structure.

For further details on the composition according to the invention, reference is made to the above explanations on the other aspects of the invention, which apply accordingly to the inventive composition.

Another subject-matter of the present invention—according to a fourth aspect of the present invention—is the use of a liquid composition, in particular a solution or dispersion, preferably as described above, for the production of a silicon carbide-containing structure by additive manufacturing, in particular according to the method described above.

For further details on the use in accordance with the invention, reference is made to the above explanations on the other aspects of the invention which apply accordingly to the inventive use.

Further subject-matter of the present invention—according to a fifth aspect of the present invention—is an apparatus for the production of silicon carbide-containing structures from liquid starting materials by additive manufacturing, wherein the apparatus includes
(a) a construction field,
(b) at least one discharge device for spreading a liquid solution or dispersion, in particular on the construction field, and
(c) at least one radiation device for irradiating the applied solution or dispersion.

In the context of this invention, it is usually provided that the construction field comprises a carrier plate or structure. The silicon carbide-containing structure is preferably produced on the construction field, in particular the carrier plate or the carrier structure. In this context it is preferred if the construction field is a carrier plate.

In the context of the present invention, it is generally intended that the carrier plate or carrier structure extends in one plane, in particular a horizontal plane or an xy plane, and is designed to be movable, in particular to be movable at least in the x and y directions. The carrier plate or carrier structure is preferably movable in the x, y and z direction, in particular independently of each other. In the context of the present invention, a construction field is the area of the apparatus on which the silicon carbide-containing structure is produced. X-, y- and z-directions indicate the three spatial directions.

In accordance with a special embodiment of the present invention, it may also be provided that the carrier plate or carrier structure can be tilted from the xy-plane, in particular in the z-direction.

In addition, it may also be envisaged within the scope of the present invention that the carrier plate can be rotated, in particular in the xy plane. Such a movable, tiltable and/or rotatable carrier plate or carrier structure is used in particular if the silicon carbide-containing structure, in particular a silicon carbide-containing body, is not built up in layers, but if new material is to be applied to almost any position of the silicon carbide-containing structure or a complex substrate. This special embodiment of the present invention can be used, for example, in the repair of damaged silicon carbide-containing components or in the area-wise coating of metallic or silicon carbide-containing substrates.

Usually, however, a classical layer-by-layer production of the silicon carbide-containing structure, as it is common in generative manufacturing methods, is carried out.

In the context of the present invention, it is preferably intended that the discharge device should have at least one spreading means, in particular a nozzle, for spreading a solution or dispersion.

According to a preferred embodiment of the present invention, the discharge device has 1 to 500,000, in particular 10 to 200,000, preferably 100 to 100,000, more preferably 500 to 100,000, spreading means.

The discharge device thus usually has a large number of spreading means, in particular nozzles, which enables rapid application of a carbon- and silicon-containing solution or dispersion, in particular a SiC precursor sol. In the context of the present invention, a spreading means is a means which is suitable for the delivery of a solution or dispersion, in particular by printing.

In the context of the present invention, it is usually provided that the discharge device is movable, in particular in at least one plane, in particular in the xy direction, but preferably movable in the x, y and z direction. The discharge device is preferably designed in the form of a carriage which has a plurality of spreading means, in particular nozzles, which is moved rapidly over the construction field area and in doing so applies a solution or dispersion, in particular a SiC precursor sol, to a substrate.

In the context of the present invention it is advantageously provided that the discharge device, in particular the spreading means, produces drops of a liquid, in particular a solution or dispersion, with a resolution of 100 to 10,000,000,000 drops/cm², in particular 2,500 to 400,000,000 drops/cm², preferably 10,000 to 100,000,000 drops/cm², more preferably 40,000 to 25,000,000 drops/cm².

Similarly, the present invention may provide that the discharge device, in particular the spreading means, produces drops of a liquid, in particular a solution or dispersion, having a drop diameter of 0.1 to 500 μm, in particular 0.5 to 200 μm, preferably 1 to 100 μm, more preferably 2 to 50 μm. In the context of the present invention, a solution or dispersion can thus be applied in high resolution to a substrate or the carrier plate or a layer of the silicon carbide-containing structure.

In the context of the present invention, at least one storage device, in particular a storage vessel, for the storage of a solution or dispersion, in particular a precursor sol or a component of a precursor sol, is usually associated with the discharge device, in particular with the spreading means.

In this context, it may be provided that individual spreading means or groups of spreading means are assigned to different storage devices, in particular each containing different precursor sols or different components of precursor sols. Within the scope of the present invention, it may therefore be the case that different solutions or dispersions, in particular different precursor sols or also components thereof, are provided in different storage devices and are applied separately each via fixed or variably assigned spreading means, in particular nozzles. By applying different precursor sols, the electrical and mechanical properties of the silicon carbide-containing structure can be specifically adjusted in certain areas so that, for example, complex components with different material properties in certain areas can be provided.

In addition, it is also possible that non-carbon and silicon-containing solutions or dispersions or SiC precursor sols, which already contain all components of the silicon carbide-containing compound, are used, instead of solutions or dispersions, especially precursor sols, which only contain individual components of the SiC precursor sol.

These solutions or dispersions containing only components can either be mixed in a mixing and dosing device before application to the substrate or applied as separate components to the substrate, in which case the mixing and formation of the carbon- and silicon-containing solution or dispersion takes place only on the substrate. For in-situ mixing on the substrate, it is necessary to apply several very small drops of suitable viscosity to the same position on the substrate that, in particular, mix at a suitable temperature to form a drop before a conversion to the corresponding silicon carbide-containing compound takes place under the effect of energy.

In accordance with a special embodiment of the present invention, it is intended that a mixing and dosing device is arranged between the discharge device, in particular the spreading means, and the storage device, in particular for mixing different components of a precursor sol from different storage devices. In this case, a mixing and dosing device is to be installed between the storage vessel and the spreading means, in which more precisely dosed quantities of different solutions or dispersions, in particular components of a precursor sol, are mixed in the correct proportions.

In general, it is preferred in this context if the different solvents or dispersants of the single components are miscible with each other and the components can consequently dissolve into each other, so that optimal mixing and homogeneous doping or alloying is possible. In the case that MAX phases are to be produced, however, it can also be advantageous to select solvents or dispersants which do not dissolve into each other, so that the mixing leads to colloidal suspensions. By the variable preparation of the solution or dispersion, in particular the precursor sol, in the form of several components, the additive production can be realized with a small number of storage devices for the production of a large variety of material properties, which can be combined in one workpiece if necessary. The material properties are determined on the one hand by the mixtures provided in the storage devices and on the other hand by the process parameters implemented in the apparatus, which include both the mixture on site and the process parameters. This makes it possible to produce highly complex workpieces in a decentralized manner according to local requirements for geometry and material properties.

In the context of the present invention it is usually intended that the application of the solution or dispersion by means of the discharge device, in particular the spreading means, is controlled by a control device.

According to a preferred embodiment of the present invention, it is intended that the radiation device emits electromagnetic radiation with a point-like effective range. Particularly good results are obtained in this context if the radiation device emits electromagnetic radiation with a point-like effective range of a diameter in the range of from 0.1 to 1,000 μm, in particular 0.5 to 500 μm, preferably 1 to 200 μm, more preferably 2 to 100 μm.

Particularly good results are obtained in the context of the present invention if the radiation device emits laser radiation. In particular, high amounts of energy, which are required for the decomposition or cleavage of the precursor compounds used, can be introduced locally and sharply limited by laser radiation.

If the radiation device emits laser radiation, the radiation device usually has means for generating laser beams and/or means for aligning laser beams, in particular means for deflecting laser beams.

According to an embodiment of the present invention, it may be that the radiation device has means for aligning radiation, in particular wherein the radiation device has 1 to 200, in particular 5 to 100, preferably 10 to 50, means for aligning radiation. In the context of the present invention, a means for aligning radiation is to be understood as a means which enables the precise alignment of a beam of electromagnetic radiation, in particular in the form of a light guide or in the form of deflecting means, such as, for example, a mirror arrangement. In particular, laser radiation, which is generated with a means for generating laser radiation, can be directed flexibly and without deflecting means to the respective place of use via the means for aligning radiation.

In particular, it is possible within the context of the present invention that the radiation device, in particular the means for aligning radiation, are associated with the discharge device, in particular are mounted on or in the discharge device. In accordance with this preferred embodiment of the present invention, the discharge device has not only spreading means, in particular nozzles, for spreading a solution or dispersion, in particular a precursor sol, but also means for aligning radiation, through which the area covered with the solution or dispersion, in particular the precursor sol, can be immediately converted with electromagnetic radiation, in particular laser radiation, to the corresponding silicon carbide-containing compound immediately after application of the solution or dispersion, in particular the precursor sol.

For further details on the apparatus according to the invention, reference is made to the above explanations regarding the other aspects of the invention which apply accordingly to the apparatus according to the invention.

The subject-matter of the present invention is explained in the following in a non-restrictive manner by means of the figures on the basis of preferred forms of execution.

FIG. 1 shows a cross-section along an xz plane through an apparatus according to the invention 1 for the production of a silicon carbide-containing structure 2. In the figure, the silicon carbide-containing structure 2 is represented as a three-dimensional object, i.e. as a body, the production of which has not yet been completed.

The silicon carbide-containing structure 2 is arranged on a construction field 3, in particular a construction panel in the form of a carrier plate, and is fastened thereto in particular. The apparatus 1 usually has at least one discharge device 4 with one or more spreading means 5, in particular one or more nozzles, for spreading a solution or dispersion, in particular a precursor sol. The discharge device 4 preferably has 1 to 500,000, in particular 10 to 200,000, preferably 100 to 100,000, more preferably 500 to 100,000, spreading means 5, in particular nozzles, for spreading a solution or dispersion, in particular a precursor sol.

Within the scope of the present invention, it may in particular be provided that either the construction field 3 and/or the discharge device 4 can be moved, in particular in a xy plane, preferably in x, y and z direction. Usually, however, it is sufficient if only the discharge device 4 or the construction field 3 can be moved in order to enable an optimum application of a solution or dispersion onto the construction field 3 or the silicon carbide-containing structure 2.

However, it can also be provided, for example, that the discharge device 4 can be moved in an xy plane, while the construction field 3 can be moved in the z direction, so that an optimum distance is always maintained between the discharge device 4 and the substrate, i.e. the silicon carbide-containing structure 2 or the construction field 3, when the silicon carbide-containing structure 2 is built up in successive layers. In accordance with an alternative embodiment, however, it may also be provided that the construction field 3 in particular is tiltable, in particular tiltable in the z-direction, and/or rotatable about an axis, in particular an axis in the z-direction. In this way, new material can be applied to almost any part of the silicon carbide-containing structure 2.

This embodiment is suitable, for example, for special applications such as the area-wise coating of complex components or for repairing material defects and damage in a silicon carbide-containing structure 2.

The spreading means 5, in particular nozzles, are usually designed in such a way that they can apply a solution or dispersion with a resolution of 400 to 10,000,000,000 drops/cm2, in particular 2,500 to 400,000,000 drops/cm2, preferably 10,000 to 100,000,000 drops/cm2, more preferably 40,000 to 25,000,000 drops/cm2, to the silicon carbide-containing structure 2 or construction field 3.

The discharge device 4, in particular the spreading means 5, is preferably designed in such a way that a solution or dispersion is applied to a substrate, in particular a silicon carbide-containing structure 2 or a construction field 3, by an ink-jet printing process.

In addition, the apparatus 1 usually has at least one radiation device 6, which according to the example shown in the figure consists of a means for generating laser beams 7, in which laser beams 8 are generated, and means 9 for aligning radiation, in particular laser radiation, such as deflecting means for deflecting laser beams, in particular a mirror arrangement. In addition, however, other superstructures are also possible, in which, for example, the laser beams 8 generated in the means for generating laser beams 7 are flexibly deflected onto a surface to be irradiated by means of other means 9 for aligning, for example, light guides, in particular glass fiber diodes.

The mode of action of the method according to the invention is described in the following on the basis of FIGS. 2 and 3.

FIG. 2 shows an enlarged section of FIG. 1, in which the upper part of the silicon carbide-containing structure 2 shown in FIG. 1 is shown. A solution or dispersion 10, in particular a SiC precursor sol, is applied to the silicon carbide-containing structure 2 by means of the spreading means 5, in particular nozzles, arranged at the discharge device 4, onto the silicon carbide-containing structure 2, so that a layer 11 of the solution or dispersion 10, in particular of the precursor sol, is formed. The production of silicon carbide-containing structures shown in the figure is thus carried out by the classical layer-by-layer process, in particular, if necessary, using supporting structures. If the viscosity and/or stickiness of the solution or dispersion 10, in particular of the precursor sol, is suitably adjusted, even overhanging structures without supporting structures can be created. In the figure illustrations, the discharge device 4 is shown with a spreading means 5, in particular a nozzle, for clarification purposes only. Usually, however, the discharge device 4 has a large number of spreading means 5, in particular nozzles.

After a layer 11 of solution or dispersion 10, in particular precursor sol, has been applied, the discharge device is preferably moved to a rest position so that construction field 3 and/or the silicon carbide-containing structure 2 can be irradiated. For this purpose, laser beams 8 are generated in the means 7 for generating laser beams, which are guided onto the layer 11 of the solution or dispersion 10 via radiation alignment means 9, in particular deflection means. At the points where the laser beam 8 strikes the layer 11, the solution or dispersion 10, in particular the SiC precursor sol, is converted to a silicon carbide-containing compound and a further part, in particular a further layer, of the silicon carbide-containing structure 2 is produced.

FIG. 4 shows how a plurality of spreading means 5a to Se is connected to a plurality of storage devices 12a to 12e. The storage devices 12a to 12e contain solutions or dispersions, in particular different SiC precursor sols or components for the production of precursor sols, in particular SiC precursor sols. The spreading means Sa to Se are connected to the storage devices 12a to 12e via lines 13. The dosing and control of the individual nozzles is carried out via a control device 14.

In accordance with the design shown in FIG. 4, it is now possible that the same solution or dispersion, in particular the same precursor sol, is present in all storage devices 12a to 12e, but it is also possible that different components of precursor sols or different precursor sols are present in the individual storage devices 12a to 12e.

FIG. 5 shows a further embodiment of the present invention, in which the spreading means Sa to Se are assigned to a discharge device 4 and are connected to the storage devices 12a to 12e via a mixing and dosing device 15. In this case, the storage devices 12a to 12e each preferably contain different components of precursor sols which are mixed in the mixing device 15 and then fed to the spreading means 5a to Se. The control is also carried out via a control device 14.

FIG. 6 finally shows a preferred embodiment of the present invention, in which the discharge device 4 has on the one hand several spreading means 5a to 5d and, in addition, at least one radiation device 6. The radiation device 6, in particular, is usually not the complete radiation device 6, but is, for example, a means for aligning radiation, for example an optical fiber. This special design enables one or more solutions or dispersions 10, in particular a precursor sol or components of a precursor sol, to be applied to a silicon carbide-containing structure 2 or a construction field 3 via the spreading means 5a to 5d and, immediately after the solution or dispersion 10 has been applied, it is converted into a silicon carbide-containing compound by irradiation with laser beams 8. In particular, it is possible that the discharge device 4 has not only a plurality of spreading means 5, in particular nozzles, but also a plurality of radiation devices 6 or a plurality of means for aligning radiation, in particular light guides, which are connected to a radiation source.

Reference signs:

| | |
|---|---|
| 1 | apparatus |
| 2 | structure |
| 3 | construction field |
| 4 | discharge device |
| 5a-e | spreading means |
| 6 | radiation device |
| 7 | means for generating laser |
| | beams |
| 8 | laser beam |
| 9 | means for aligning radiation |
| 10 | solution/dispersion |
| 11 | layer of precursor sol |
| 12a-e | storage device |
| 13 | line |
| 14 | control device |
| 15 | mixing and dosing device |

1. Method for the production of a silicon carbide-containing structure, in particular by additive manufacturing,
characterized in that
(a) in a first method step, a carbon- and silicon-containing solution or dispersion, in particular a SiC precursor sol, preferably a layer of a carbon- and silicon-containing liquid, in particular of a SiC precursor sol, is applied to a substrate and
(b) in a second method step following the first method step (a), the carbon- and silicon-containing solution or dispersion, preferably the layer of the carbon- and silicon-containing solution or dispersion, is converted, in particular at least in some areas, by the effect of energy into a silicon carbide-containing compound, so that a part, in particular a layer, of the silicon carbide-containing structure is produced,
wherein method steps (a) and (b) are repeated until the silicon carbide-containing structure is obtained.

2. Method according to claim 1, characterized in that the silicon carbide-containing compound is selected from silicon carbide, non-stoichiometric silicon carbides, doped silicon carbides and silicon carbide alloys.

3. Method according to claim 1, characterized in that the carbon- and silicon-containing solution or dispersion, in particular the SiC precursor sol, is applied to the substrate with a layer thickness in the range of from 0.1 to 250 μm, in particular from 0.2 to 100 μm, preferably from 0.5 to 50 μm, more preferably from 1 to 25 μm.

4. Method according to claim 1, characterized in that the carbon- and silicon-containing solution or dispersion, in particular the SiC precursor sol, is applied to the substrate by a coating method.

5. Method according to claim 4, characterized in that the coating method is selected from rotary coating, dip coating, spray application and printing methods, in particular ink jet printing.

6. Method according to claim 1, characterized in that the carbon- and silicon-containing solution or dispersion, in particular the precursor sol, is applied to the substrate over the entire surface or locally, in particular regioselectively.

7. Method according to claim 1, characterized in that the carbon- and silicon-containing solution or dispersion, in particular the SiC precursor sol, is heated by the effect of energy, at least in some areas, to temperatures in the range of from 1,600 to 2,100° C., in particular from 1,700 to 2,000° C., preferably from 1,700 to 1,900° C.

8. Method according to claim 1, characterized in that in the second method step (b) the effect of energy is achieved by electromagnetic radiation, in particular by laser radiation.

9. Method according to claim 1, characterized in that the energy effect, in particular by means of electromagnetic radiation, is locally limited, in particular regioselective.

10. Method according to claim 1, characterized in that the carbon- and silicon-containing solution or dispersion, in particular the SiC precursor sol, has a dynamic viscosity according to Brookfield at 25° C. in the range of from 3 to 500 mPas, in particular from 4 to 200 mPas, preferably from 5 to 100 mPas.

11. Method according to claim 1, characterized in that several different carbon- and silicon-containing solutions or dispersions, in particular SiC precursor sols, are used in method step (a).

12. Method according to claim 11, characterized in that in method step (a) the different carbon- and silicon-containing solutions or dispersions, in particular the SiC precursor sols, are applied to the substrate using different spreading means, in particular nozzles.

13. Method according to claim 1, characterized in that at least method step (b) is carried out in a protective gas atmosphere, in particular an inert gas atmosphere.

14. Silicon carbide-containing structure obtainable by a method according to claim 1.

15. Composition, in particular SiC precursor sol, in the form of a solution or dispersion, containing
(A) at least one silicon-containing compound,
(B) at least one carbon-containing compound,
(C) at least one solvent or dispersant; and
(D) optionally, doping and/or alloying reagents.

16. Composition according to claim 15, characterized in that the solvent or dispersant is selected from water and organic solvents and mixtures thereof, preferably mixtures thereof.

17. Composition according to claim 15, characterized in that the silicon-containing compound is selected from silanes, silane hydrolysates, orthosilicic acid and mixtures thereof, in particular silanes.

18. Composition according to one of claim 15, characterized in that the carbon-containing compound is selected from the group of sugars, in particular sucrose, glucose, fructose, invert sugar, maltose; starch; starch derivatives; organic polymers, in particular phenol formaldehyde resin and resorcinol formaldehyde resin, and mixtures thereof.

19. Use of a liquid composition, in particular a solution or dispersion, preferably according to claim 15, for the production of a silicon carbide-containing structure by additive manufacturing, in particular according to a method according to claim 1.

20. Apparatus for the production of silicon carbide-containing structures from liquid starting materials by additive manufacturing,
characterized in that
the apparatus includes
(a) a construction field,
(b) at least one discharge device for spreading a liquid solution or dispersion, in particular on the construction field, and
(c) at least one radiation device for irradiating the applied solution or dispersion.
